(19) United States
(12) Patent Application Publication
(10) Pub. No.: US 2006/0157264 A1
(43) Pub. Date: Jul. 20, 2006

(54) Electrical box with deflectable side walls

(76) Inventors: Herman Cardenas, Austin, TX (US); Jens Bolleyer, Arden Hills, MN (US); Jeffrey Wilson, Colgate, WI (US); Robert Marvin, Farmington, CT (US); Randolph Maxwell, El Paso, TX (US); Kevin Patin, El Paso, TX (US)

Correspondence Address: JOHN E. TOUPAL, 116 CONCORD STREET, FRAMINGHAM, MA, 01701, US

(21) Appl. No.: 10/488,799

(22) PCT Filed: Sep. 5, 2002
(86) PCT No.: PCT/US02/28087

§ 371 Date: Dec. 19, 2005

Related U.S. Application Data
(60) Provisional application No. 60/317,534, filed on Sep. 6, 2001.

(51) Int. Cl. H02G 3/08

(52) U.S. Cl. 174/50

(57) ABSTRACT

An electrical box (100) for mounting between adjacent studs of a structural wall and having side panels (102, 103) defining spaced apart stress relief regions (182) each encompassing a mounting hole (184) and outwardly deflectable in response to actuation of a fastener through the hole (184) into penetrating engagement with a stud.

### BACKGROUND OF THE INVENTION

Electrical wiring and component boxes are customarily mounted between adjacent wall studs of building structures. The boxes are typically made with side panels spaced apart a distance slightly less than the spacing between studs. However, in some applications distortion or misalignment of studs creates an excessive spacing between studs. In that case, mounting of a box with screw fasteners extending through mounting holes into penetrating engagement with the studs can produce forces causing undesirable distortion of the box.

The object of this invention, therefore, is to provide an improved electrical box which will resist undesirable deformation when mounted between distorted or misaligned studs.

### SUMMARY OF THE INVENTION

The invention is a box for electrical components and wiring and adapted for mounting between adjacent studs of a structural wall, the box including parallel, spaced apart right and left side panels; parallel, spaced apart top and bottom panels having ends joined to ends of the right and left panels and arranged orthogonally therewith so as to form a cubic chamber; a back panel joining rear edges of the panels; and wherein each of the right and left side panels define a plurality of vertically spaced apart mounting holes for receiving fasteners actuatable into penetrating engagement with the adjacent studs, and each of the right and left side panels define around the holes stress relief regions adapted to deflect outwardly in response to actuation of the fasteners. The stress relief regions prevent other deformation of the box when being mounted between distorted studs.

According to one feature of the invention, the region defines slots partially encompassing the hole. The slots establish the desired deflectability for the stress relief regions.

According to another feature, the slots comprise a pair of substantially parallel slots straddling the hole. The parallel slots efficiently provide the desired stress relief.

In one embodiment the slots include a second pair of slots aligned with the hole and straddled by and parallel to the parallel slots. The second pair of slots enhances the effectiveness of the stress relief regions.

In another embodiment, the slots include a third slot joining ends of the pair of parallel slots. The third slot substantially improves the deflection characteristics of the stress relief regions.

According to another feature, the hole is defined in an outwardly indented central portion of the region. The indented portion simplifies mounting of the box.

According to yet another feature of the invention, each hole is horizontally elongated. The elongated holes accommodate proper alignment of the box between studs.

### BRIEF DESCRIPTION OF THE DRAWINGS

These and other objects and features of the invention will become more apparent upon a perusal of the following description taken in conjunction with the accompanying drawings wherein:

FIG. 1 is a perspective view of a structured wiring box according to the preferred embodiment of the invention;

FIG. 2 is a cross-sectional view taken along lines 2-2 of FIG. 1;

FIG. 3 is a perspective view of the structured wiring box of FIG. 1 with the cover door, module door, and computer server door opened;

FIG. 4 is an exploded perspective view of the structured wiring box of FIG. 1;

FIG. 5 is a left side view of the structured wiring box of FIG. 1;

FIG. 6 is a front view of the structured wiring box of FIG. 1 with the cover door opened;

FIG. 7 is a detailed view of the trim ring of the structured wiring box of FIG. 1; and

FIG. 8 is a partial view of another side panel embodiment of the invention.

### DETAILED DESCRIPTION OF THE PREFERRED EMBODIMENT

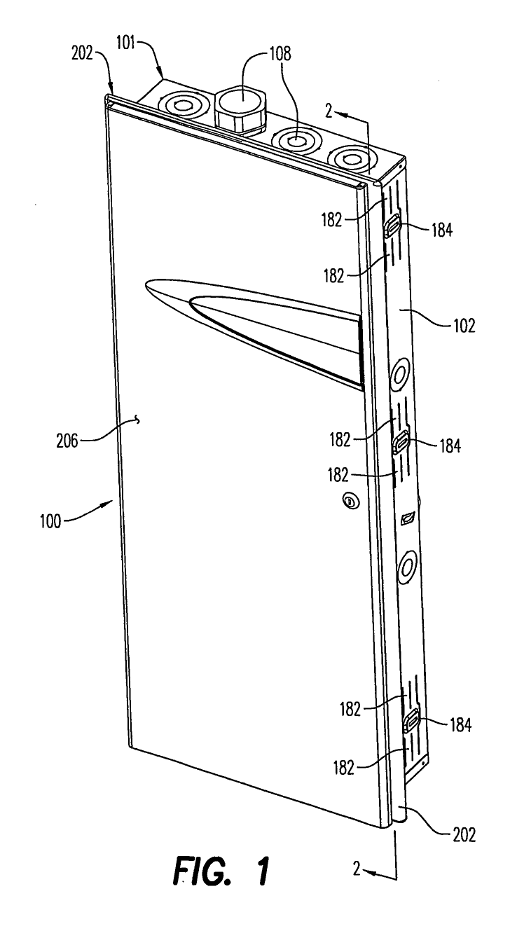

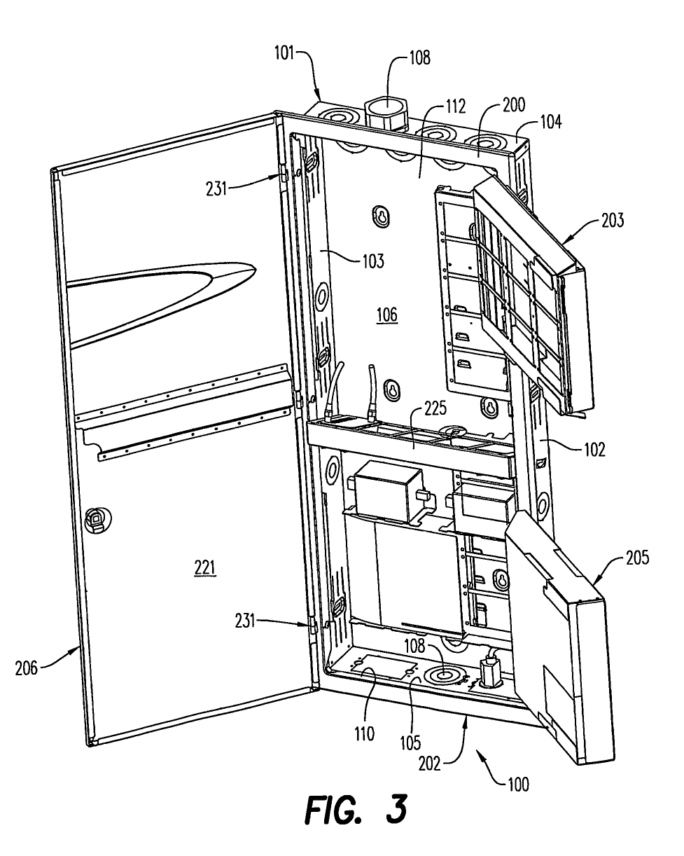

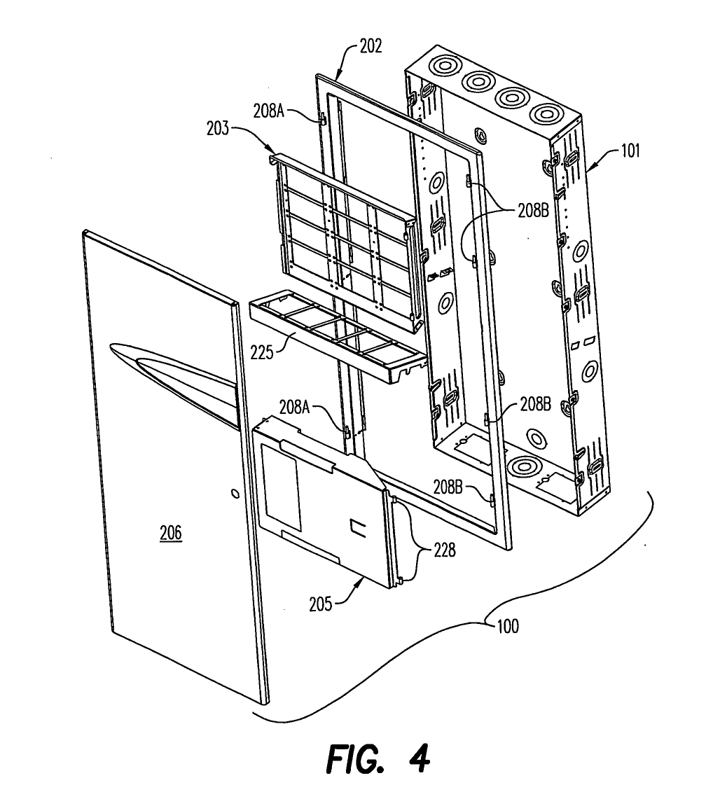

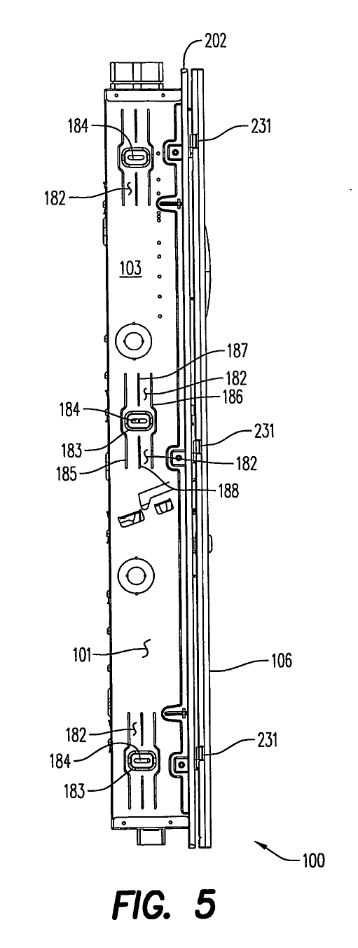

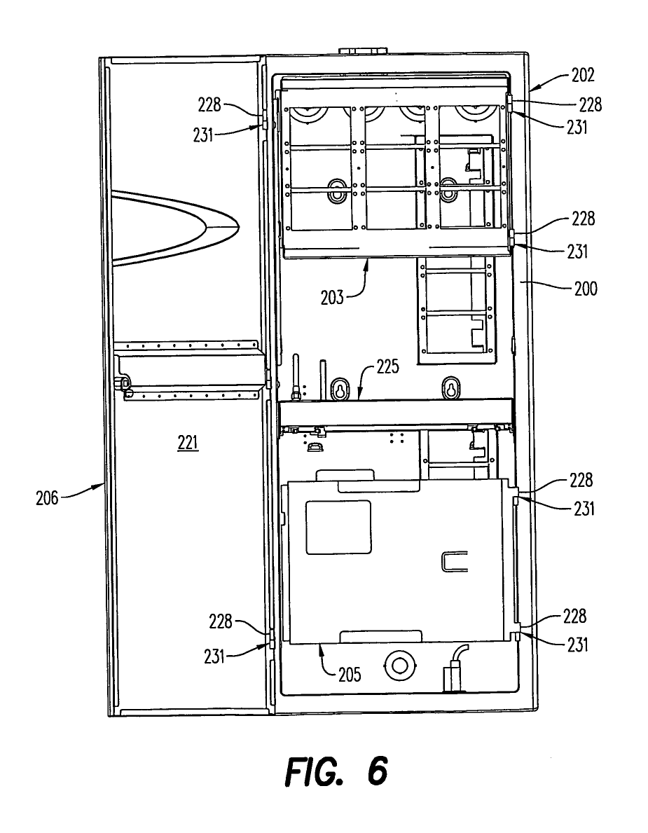

A structured wiring box 100 according to the preferred embodiment of the invention is depicted in FIGS. 1 through 7. The structured wiring box 100 consists of a base box housing 101 that fits between standard sixteen-inch-on-center wall studs. As shown in FIG. 3, the base box 101 is formed by right and left side panels 102, 103, a top panel 104, a bottom panel 105, and a back panel 106. Together, the panels 102-106 form a housing chamber 112 having a front opening 110. Both the right and left side panels 102, 103 and the top and bottom panels 104, 105 are parallel and arranged orthogonally with the also parallel back panel 106 and opening 110 such that the housing 100 and housing chamber 112 are cubic. Formed in the top and bottom panels 104, 105 are access ports 108 for entry and exit of wiring extending into and out of the chamber 112. Preferably, the right and left panels 102, 103 are spaced slightly less than sixteen inches apart to facilitate mounting of the box 101 between wall studs (not shown).

In a default minimum configuration, a flat front cover (not shown) is used to close the structured wiring box 100 and hide the rough edges of sheet rock surrounding the mounting hole in the house's wall. All wires, components, and modules are contained within a volume 112 (FIG. 3) defined by the base box 101 and a flat front cover (not shown).

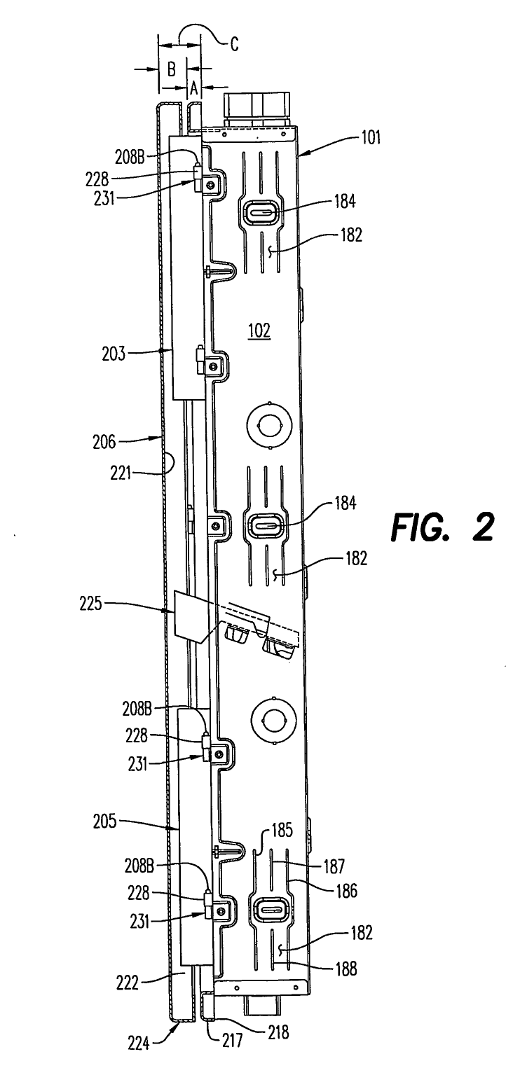

As illustrated in FIGS. 1 and 2, each side panel 102, 103 of the box 101 has a plurality of vertically spaced apart regions 182 which are flexible to allow adjustment of the box 101 within warped studs. Centrally located within each region 182 is a horizontally elongated mounting slot 184 for receiving a suitable fastener (not shown) such as a screw. Each slot 184 is positioned in an outwardly indented bracket portion 183 of the region 182. Formed within each region 182 are a pair of vertically oriented stress relief slots 185, 186 located on opposite sides of each mounting slot 184 and another vertical pair including one slot 187 located above the mounting slot 184 and straddled by and parallel to the stress relief slots 185, 186 and another slot 188 located below the mounting slot 184 and straddled by and parallel to stress relief slots 185, 186. Thus, the relief slots 185-188 partially encompass the stress relief regions 182. During the insertion of screw fasteners (not shown) through the mounting slots 184 and into penetrating engagement with warped adjacent studs (not shown) of a wall, the stress relief regions 182 can deflect outwardly and thereby prevent other deformation of the box 101. Thus, the structured wiring box 101 maintains its form in spite of being tightly anchored to imperfect studs.

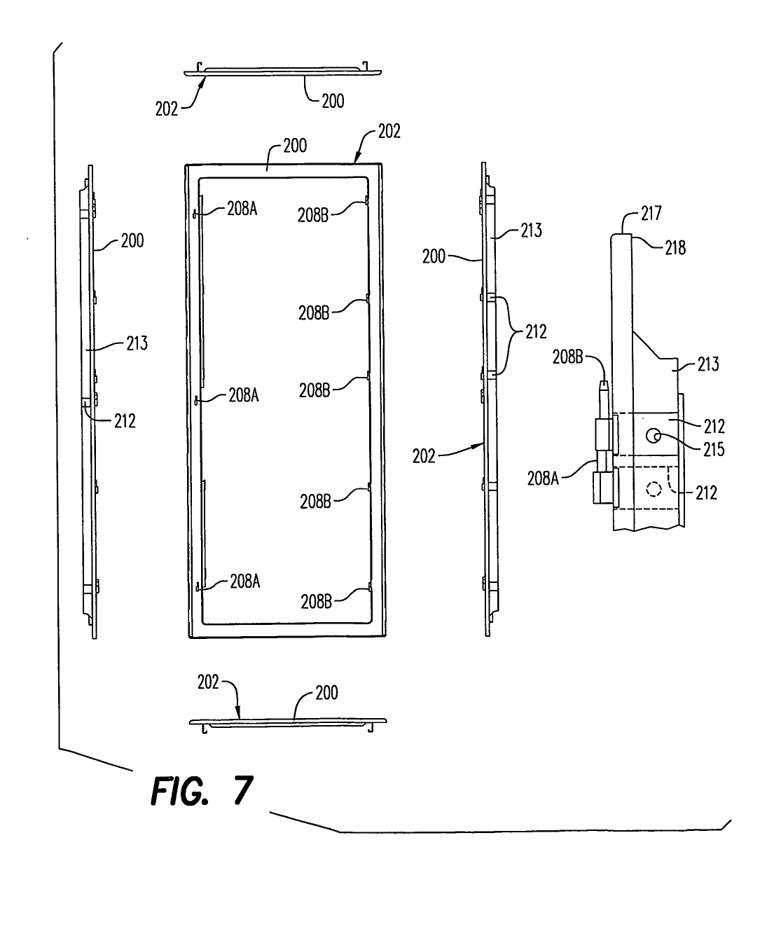

For non-minimal configurations, or when retrofitting significant upgrades, a decorative trim ring 202 (FIG. 7) is secured to the outer edge of the box 101. The trim ring 202 includes a flange portion 203 extending parallel to the wall space so as to hide rough edges of the sheet rock hole providing a pleasing appearance for the unit on the wall. Other functions of the trim ring 202 are provided by built-in hinge pins 208A spaced along a left vertical section 209 of the trim ring 202 and hinge pins 208B spaced along a right vertical section 211 of the trim ring 202. The hinge pins 208A, 208B are mounted on tabs 212 secured to a sheet metal strip 213 projecting inwardly from an inner periphery of the trim ring 202. Holes 215 extending through the tabs 212 and strip 213 receive screws (not shown) that secure the ring 202 to inner surfaces of the side panels 102, 103 of the box 101. The outer periphery of the trim ring 202 (FIG. 2) is formed by an inwardly curved rim 217 having an edge 218 for engaging the wall face (not shown) surrounding the box 101. Hinge pins 208A allow the easy addition of an outwardly projecting swinging cover door 206 as described below while hinges 208B allow the easy addition of swinging electrical component and module retaining doors 203, 205 (FIG. 3). Thus, addition of the trim ring 202 allows for upgrading without replacement of base box 101.

The hinge pins 208A allow a default cover (not shown) to be easily replaced with the outwardly projecting cover door 206. During such replacement, the hinge pins 208A receive hinge sleeves 228 mounted on door 206. Together, the pins 208A and sleeves 228 form hinges 231 which allow swinging movement of the door between a closed position covering a composite chamber including the housing chamber 112 and extension chamber 222 (described below) and an open position allowing access thereto. Similar, hinge sleeves 218 are provided on the module doors 203, 205. As shown in FIG. 2, an inner surface 221 of the cover door 206 is outwardly spaced from the trim ring 202 by a distance B so as to establish a portion of an extension chamber 222 having a depth C. The space between the inner door surface 221 and the trim ring 202 is concealed by an inwardly projecting rim 224 along the perimeter of the door 206. In addition, the depth A of the trim ring 102 provided by the rim 217 establishes another portion of the extension chamber 222 which accommodates more and/or larger components. The extension chamber 222 provides space for modules and components that are otherwise too large to fit only within housing chamber 112. For example, the extension chamber accommodates the swinging module doors 203, 205 as well as an outer portion of a removable rack 225 for retaining electrical components. Consequently, a new house built with minimal structured wiring cost can later support very complex configurations and many additional or larger components as upgrades or retrofit options are desired.

The hinges 231 are made with the bottom hinge pin 208A, 208B of a set longer than the others to allow for easier installation of the door 206 and modules 203, 205. The different length hinge pins allow the bottom hinge pin to be aligned with a hinge sleeve 228 and partially slid on without alignment of the other hinges. Once a bottom hinge sleeve 228 has been partially slid on a bottom pin 208, the remaining pins and sleeves are aligned and the door or module is moved into a fully retained position.

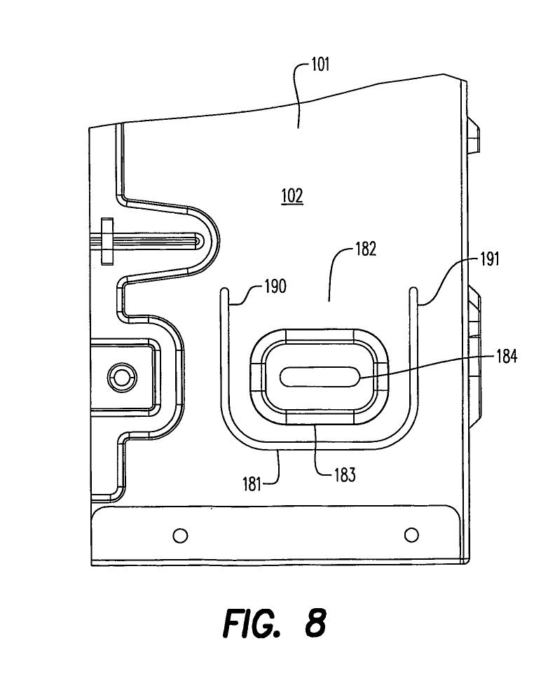

FIG. 8 illustrates another side panel embodiment providing stress relief when the box 101 is mounted between warped or distorted studs. As in the side panels 102, 103 of the embodiment shown in FIGS. 1-7, a side panel 102 includes a plurality of vertically spaced apart, horizontally elongated mounting slots 184 each surrounded by a stress relief region 182. The mounting slots 184 again are formed in outwardly indented bracket portions 183 of the regions 182. Establishing each stress relief region 182 in the FIG. 8 embodiment are a pair of substantially parallel slots 190, 191 straddling the mounting slot 184 and a third slot 181 joining ends of the slots 190, 191, so as to partially encompass the mounting slot 184. As described above, the region 182 will deflect outwardly when screw fasteners (not shown) are actuated through the mounting slots 184 into penetrating engagement with deformed studs.

It should be understood that the afore-described is merely the preferred one of many possible embodiments of the invention, and that the scope of the invention should therefore only be limited according to the following claims.

1. A box for electrical components and wiring and adapted for mounting between adjacent studs of a structural wall and said box and comprising:
parallel, spaced apart right and left side panels;
parallel, spaced apart top and bottom panels having ends joined to ends of said right and left panels and arranged orthogonally therewith so as to form a cubic chamber;
a back panel joining rear edges of said panels; and wherein
each of said right and left side panels define a plurality of vertically spaced apart mounting holes for receiving fasteners actuatable into penetrating engagement with the adjacent studs, and each of said right and left side panels define around said holes stress relief regions adapted to deflect outwardly in response to actuation of the fasteners and thereby prevent other deformation of the box when being mounted between warped studs.

2. A box according to claim 1 wherein each said region defines slots partially encompassing said hole.

3. A box according to claim 2 wherein said slots comprise a pair of substantially parallel slots straddling said hole.

4. A box according to claim 3 wherein said slots comprise a second pair of slots aligned with said hole and straddled by and substantially parallel to said parallel slots and disposed on opposite sides of said hole.

5. A box according to claim 3 wherein said slots include a third slot joining said pair of substantially parallel slots.

6. A box according to claim 1 wherein each said hole is defined in an outwardly indented central portion of said region.

7. A box according to claim 6 wherein each said region defines slots extending partially around said hole.

8. A box according to claim 7 wherein said slots comprise a pair of vertical slots straddling said hole.

9. A box according to claim 8 wherein said slots comprise a second pair of slots aligned with said hole and straddled by and substantially parallel to said parallel slots and disposed on opposite sides of said hole.

10. A box according to claim 8 wherein said slots include a third slot joining said pair of substantially parallel slots.

11. A box according to claim 1 wherein each said hole is horizontally elongated.

12. A box according to claim 11 wherein each said region defines slots extending partially around said hole.

13. A box according to claim 12 wherein said slots comprise a pair of vertical slots straddling said hole.

14. A box according to claim 13 wherein said slots comprise a second pair of slots aligned with said hole and straddled by and substantially parallel to said parallel slots and disposed on opposite sides of said hole.

15. A box according to claim 13 wherein said slots include a third slot joining said pair of substantially parallel slots.

16. A box according to claim 11 wherein each said hole is defined in an outwardly indented central portion of said region.

17. A box according to claim 16 wherein each said region defines slots extending partially around said hole.

18. A box according to claim 17 wherein said slots comprise a pair of vertical slots straddling said hole.

19. A box according to claim 18 wherein said slots comprise a second pair of slots aligned with said hole and straddled by and substantially parallel to said parallel slots and disposed on opposite sides of said hole.

20. A box according to claim 17 wherein said slots include a horizontal slot joining said pair of vertical slots.

21. A box according to claim 4 wherein said slots comprise a first pair of vertical slots straddling said hole; and a second pair of vertical slots, one said second pair disposed above said hole and the other of said second pair disposed below said hole.

22. A box according to claim 21 wherein each said hole is defined in an outwardly indented central portion of said region.

23. A box according to claim 22 wherein each said hole is horizontally elongated.

24. A box according to claim 21 wherein each said hole is horizontally elongated.
